(19) United States
(12) Patent Application Publication
(10) Pub. No.: US 2026/0157929 A1
(43) Pub. Date: Jun. 11, 2026

(54) CPR DEVICE WITH MANUAL ACTIVATION OF ACTIVE DECOMPRESSION AND FORCE MEASUREMENT OF ACTIVE DECOMPRESSION

(71) Applicant: PHYSIO-CONTROL, INC., Redmond, WA (US)

(72) Inventors: Marcus Ehrstedt, Kävlinge (SE); Jonas Lagerström, Fagersanna (SE); Lars Anders Jörgen Segerstein, Staffanstorp (SE); William Widlund, Lund (SE)

(73) Assignee: PHYSIO-CONTROL, INC., Redmond, WA (US)

(21) Appl. No.: 19/180,702

(22) Filed: Apr. 16, 2025

Related U.S. Application Data
(60) Provisional application No. 63/635,051, filed on Apr. 17, 2024.

(51) Int. Cl. A61H 31/00

(52) U.S. Cl. CPC A61H 31/006; A61H 31/008; A61H 2031/001; A61H 2201/013; A61H 2201/1215; A61H 2201/1621; A61H 2201/1626; A61H 2201/1664; A61H 2201/5061; A61H 2203/0456; A61H 2205/084

(57) ABSTRACT

In embodiments, a mechanical CPR device includes a piston having a piston rod and a piston sleeve concentric to the piston rod and configured to slide relative to the piston rod in a first direction. The mechanical CPR device can further include a spring device configured to resist movement of the piston sleeve in the first direction, the spring device having a first spring rate from a pretensioned position to a first deflection distance, the spring device having a second spring rate from the first deflection distance to a second deflection distance, the second deflection distance being greater than the first deflection distance, the second spring rate being greater than the first spring rate. Furthermore, the mechanical CPR device can include a driver coupled to the piston and configured to extend the piston toward a chest of a patient and retract the piston away from the chest of the patient.

### PRIORITY

This disclosure claims the benefit of U.S. Provisional Application No. 63/635,051, filed on Apr. 17, 2024, which is incorporated herein by reference in its entirety.

### TECHNICAL FIELD

The subject matter is related to an apparatus and methods for administering active decompressions, and, more particularly, to a system and methods for manually activating an active decompression mode on an automatic CPR device and measuring the force of such active decompressions.

### BACKGROUND

In certain types of medical emergencies a patient's heart stops working, which stops the blood from flowing. Without the blood flowing, organs like the brain will start becoming damaged, and the patient will soon die. Cardiopulmonary resuscitation (CPR) can forestall these risks. CPR includes performing repeated chest compressions to the chest of the patient, so as to cause the patient's blood to circulate some. CPR also includes delivering rescue breaths to the patient, so as to create air circulation in the lungs. CPR is intended to merely forestall organ damage and death, until a more definitive treatment is made available. Defibrillation is one such a definitive treatment: it is an electric shock delivered deliberately to the patient's heart, in the hope of restoring the heart rhythm.

Guidelines by medical experts such as the American Heart Association provide parameters for CPR to cause the blood to circulate effectively. The parameters are for aspects such as the frequency of the chest compressions, the depth that they should reach, and the full release that is to follow each of them. If the patient is an adult, the depth is sometimes required to reach 5 cm (2 in.). The parameters for CPR may also include instructions for the rescue breaths.

Traditionally, CPR has been performed manually. A number of people have been trained in CPR, including some who are not in the medical professions, just in case they are bystanders in a medical emergency event.

Manual CPR may be ineffective, however. Indeed, the rescuer might not be able to recall their training, especially under the stress of the moment. And even the best trained rescuer can become fatigued from performing the chest compressions for a long time, at which point their performance may become degraded. In the end, chest compressions that are not frequent enough, not deep enough, or not followed by a full release may fail to maintain the blood circulation required to forestall organ damage and death.

The risk of ineffective chest compressions has been addressed with CPR chest compression machines. Such machines have been known by a number of names, for example CPR chest compression machines, CPR machines, mechanical CPR devices, cardiac compressors, CPR devices, CPR systems, and so on.

The repeated chest compressions of CPR are actually compressions alternating with releases. The compressions cause the chest to be compressed from its original shape. During the releases the chest is decompressing, which means that the chest is undergoing the process of returning to its original shape. This decompressing does not happen immediately upon a quick release. In fact, full decompression might not be attained by the time the next compression is performed. In addition, the chest may start collapsing due to the repeated compressions, which means that it might not fully return to its original height, even if it were given ample opportunity to do so.

Some CPR chest compression machines compress the chest by a piston. Some may even have a suction cup at the end of the piston, with which these machines lift the chest at least during the releases. This lifting may actively assist the chest, in decompressing the chest faster than the chest would accomplish by itself. This type of lifting is sometimes called active decompression.

Active decompression may improve air circulation in the patient, which is a component of CPR. The improved air circulation may be especially critical, given that the chest could be collapsing due to the repeated compressions, and would thus be unable by itself to intake the necessary air. Additionally, lifting a patient's chest beyond a natural resting height can lower the pressure in the patient's heart and thus facilitate filling the heart with venous blood. Different lifting forces may be needed for simply helping release a patient's chest between compressions as opposed to performing cycles of active decompressions, however, and existing CPR machines with active decompression capabilities may lift patients'chests with too much force in certain situations.

Configurations of the disclosed technology address shortcomings in the prior art.

### BRIEF DESCRIPTION OF THE DRAWINGS

FIG. 1 is a perspective view of a CPR device, according to an example configuration.

FIG. 2 is a front view of the CPR device of FIG. 1, also showing a representation of a patient within the CPR device.

FIG. 3 shows details of a piston and variable spring assembly for use in a CPR device, according to an example configuration.

FIG. 4 shows details of a piston and multi-spring assembly for use in a CPR device, according to an example configuration.

FIG. 5 shows a cross-sectional view of a piston set in a standard mode, sectioned as identified in FIG. 2, according to an example configuration.

FIG. 6 shows a cross-sectional view of the piston of FIG. 5, set in an active decompression mode.

FIG. 7A shows details of a sleeve and inner components of a piston of a CPR device set in a standard mode, according to an example configuration.

FIG. 7B shows the sleeve and inner components of the piston of FIG. 7A, set in an active decompression mode.

FIG. 7C is an exploded view of the sleeve and inner components of the piston of FIG. 7A.

FIG. 7D shows details of the piston of FIG. 7A assembled with outer components, according to an example configuration.

FIG. 8A shows details of a sleeve and inner components of a piston of a CPR device, according to an additional example configuration.

FIG. 8B is an exploded view of the sleeve and inner components of the piston of FIG. 8A.

FIG. 9 shows details of a sleeve having an incorporated spring, according to an additional example configuration.

### DETAILED DESCRIPTION

As described herein, aspects are directed to a cardiopulmonary resuscitation (CPR) device that may measure a lifting force applied to a patient's chest. More specifically, configurations of the disclosed technology provide a spring mechanism utilizing both high and low spring constants to smooth and stabilize travel of the portion of the CPR device applying compressions and active decompressions and to accurately measure a lifting force applied. Configurations utilize a low spring constant (i.e., a loose spring) to correct for gaps due to tolerances of the device's parts and pretension the parts, while utilizing a high spring constant (i.e., a stiff spring) to minimize the relative displacement used to measure lifting force. In further configurations, the disclosed spring mechanism may detect whether a suction cup has detached from a patient's chest.

Additionally, configurations of the disclosed technology provide a mechanism for manually switching between a standard mode with minimal lifting and an active decompression mode with higher lifting force. Configurations may include a sleeve having a first slot for favoring a lower spring constant portion of the disclosed spring mechanism and a second slot for favoring a higher spring constant portion. Manually applying a torque to the sleeve may switch the sleeve between the positions of the first slot and the second slot, thus switching the CPR device between the standard mode and the active decompression mode.

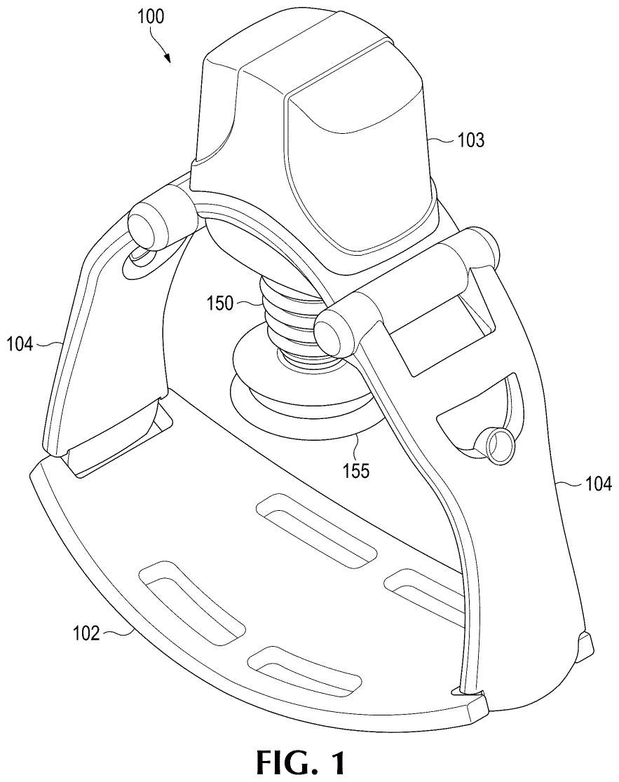

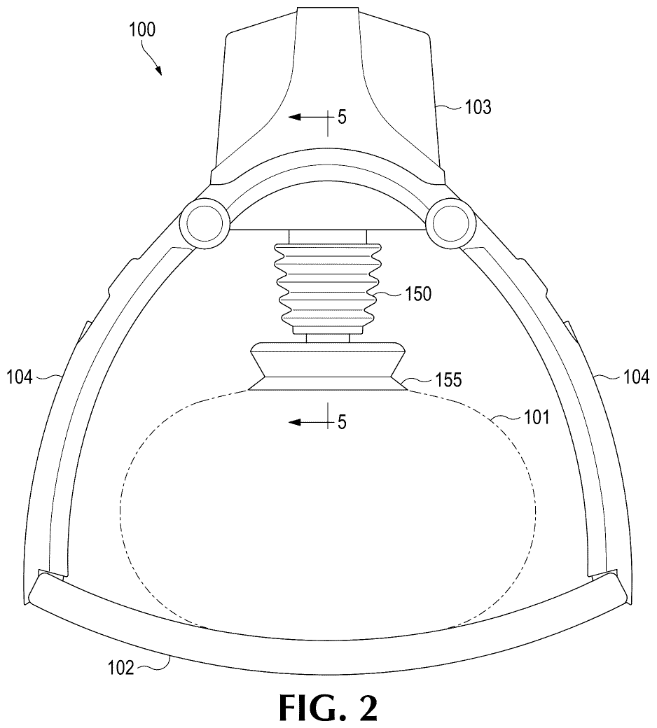

FIG. 1 is a perspective view showing portions of a CPR device 100, according to embodiments. FIG. 2 is a front view of the CPR device 100 of FIG. 1, also showing a representation of a patient 101 within the CPR device 100. As illustrated in FIGS. 1 and 2, a CPR device 100 may include a base member 102, a chest compression mechanism 103, and a support leg 104.

The chest compression mechanism 103 may be configured to deliver CPR chest compressions to the patient 101. The chest compression mechanism 103 may include, for example, a suction cup 155 and a motor-driven piston 150. The motor-driven piston 150 may be configured to contact the patient's chest to provide the CPR chest compressions, and the suction cup 155 may be configured to attach to the patient's chest to provide lifting force to the chest, also referred to as active decompressions. Still other configurations of the disclosed technology may not include the suction cup 155. In configurations, for example, the motor-driven piston 150 may instead terminate with a blunt or rounded end.

The support leg 104 may be configured to support the chest compression mechanism 103 at a distance from the base member 102. For example, if the base member 102 is underneath the patient 101, who is lying on the patient's back, then the support leg 104 may support the chest compression mechanism 103 at a sufficient distance over the base member 102 to allow the patient 101 to lay within a space between the base member 102 and the chest compression mechanism 103, while positioning the chest compression mechanism 103 over the patient's chest.

In embodiments, there may be two support legs 104. In embodiments, the two support legs 104 may together form an arch to support the chest compression mechanism 103. An example of such a configuration is illustrated in FIGS. 1-2.

Because the motor-driven piston 150 shown in FIG. 1 itself comprises several components, several mechanical tolerances may influence performance of compressions and active decompressions during implementation of the CPR device 100. For instance, piston 150 may include an internal spring assembly, which may itself have a large mechanical tolerance. Such a large mechanical tolerance of the internal spring assembly may on one hand require the spring to be compressed with very high force. On the other hand, the mechanical tolerance of the spring mechanism may, without applied force, create gaps between the spring assembly and other components of the piston 150, leading the spring assembly to not be pretensioned in its position within the piston 150 at all. With these potential problems present on either end of the mechanical tolerance of the internal spring assembly, it can be difficult to regulate the amount of current necessary to drive the piston 150 and perform smooth CPR treatment.

A loose spring may help correct for variations in mechanical tolerances, as it may take up variations in lengths of the parts and be pretensioned with the relatively low weights of the parts themselves. But, in a CPR device configured to perform active decompressions and measure lifting force based on displacement of the spring, such as in configurations discussed below, a loose spring may hinder accuracy of lifting force measurements. Consequently, a stiff spring is desirable for minimizing spring displacement and contributing to more accurate measurements of lifting force. Configurations of the disclosed technology thus provide a spring assembly utilizing springs having both low and high spring constants.

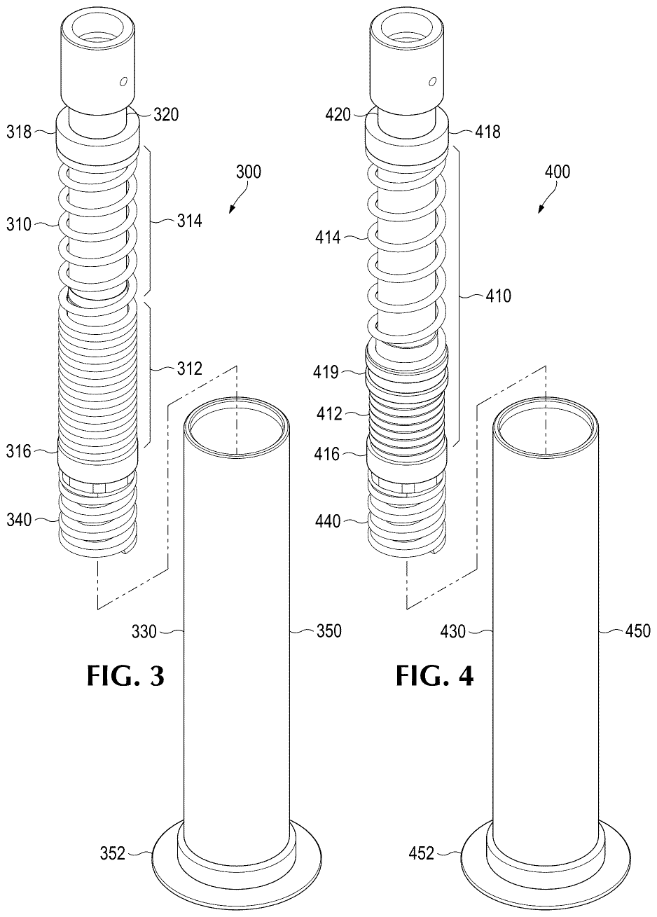

FIG. 3 illustrates a cross section of a piston assembly 300, according to configurations, showing details of springs within a piston 350. As shown, piston 350 includes a variable spring 310, having a bottom portion 312 with a low spring constant and a top portion 314 with a high spring constant. In configurations, stoppers 316, 318 may be located at opposite ends of the variable spring 310. Bottom portion 312 of variable spring 314 may therefore contact and be secured to stopper 316, and top portion 314 may contact and be secured to stopper 318, respectively. Stopper 316, in configurations, is fixed to an inner cylinder 320 and thus moves with the inner cylinder 320 when it is driven up or down, described in further detail below. In this way, stoppers 316, 318 set an initial expansion of variable spring 310 when components of the piston 350 are not in motion, providing pretension for variable spring 310. Moreover, stoppers 316, 318 facilitate compression and expansion of variable spring 310 during motion of the piston, described in further detail below.

The variable spring 310 surrounds the inner cylinder 320, which may be driven up and down in a direction along a long axis of the piston 350. Although not illustrated, the inner cylinder 320 may be attached to a ball nut mounted on a ball screw, allowing the inner cylinder to be driven up and down. As shown, piston 350 also includes an outer cylinder 330. The piston 350 also has a terminal end 352, at which a suction cup may be attached in configurations of the disclosure. Additionally, piston 350 has a stiff spring 340, which contacts and is secured to an interior portion of the outer cylinder 330 near the terminal end 352. Stiff spring 340 is also positioned to be able to contact a bottom portion of the inner cylinder 320, but it is not fixed to the inner cylinder 320. In this way, the stiff spring 340 joins the inner cylinder 320 and outer cylinder 330 such that driving the inner cylinder 320 toward the terminal end 352 acts on the stiff spring 340 and compresses the stiff spring 340 within the outer cylinder 330 while compressions are performed. Conversely, when the inner cylinder 320 is driven away from the terminal end 352 For purposes of this disclosure, the stiff spring 340 may be understood as having a high spring constant. For instance, in configurations, the spring constant of the stiff spring 340 may be higher than that of the top portion 314 of the variable spring 310.

In configurations, the stiff spring 340 has a spring constant of 100 N/mm, and the variable spring 310 has a combined spring constant of 1.5 N/mm. In configurations, the top portion 314 of the variable spring 310 has a spring constant of 20 N/mm, and the bottom portion 312 has a spring constant of 1.6 N/mm. In alternative configurations, the top portion 314 and the bottom portion 312 of the variable spring 310 have different spring constants from those just mentioned, but the series combination of the variable spring 310 is 1.5 N/mm. Consequently, most preferably, the combined spring constant of the variable spring 310 is 1.5 N/mm. Nonetheless, in still other configurations, the spring constant of the variable spring 310 may be greater or less than 1.5 N/mm.

As mentioned, piston 350 may include a motor for driving motion of the inner cylinder 320, although a motor is not illustrated in FIG. 3. Specifically, piston 350 may include a rotary motor that rotates a ball screw, causing a ball nut to translate up and down the ball screw along a long axis of the piston 350. Inner cylinder 320, being attached to the ball nut, may thus also translate up and down the ball screw and similarly cause piston 350 to translate. For instance, when the inner cylinder 320 is driven down—namely, in a direction toward the terminal end 352 of the piston 350—the stopper 316 of the inner cylinder 320 contacts the stiff spring 340. The stiff spring 340, being fixed to an interior portion of the outer cylinder 330, thus acts upon the outer cylinder 330. When the inner cylinder 320 is driven down in this way, the variable spring 310 expands. When the inner cylinder 320 is driven up—namely, in a direction away from the terminal end 352 of the piston 350—the end of the inner cylinder 320 contacting the stiff spring 340 separates from the stiff spring 340. Thus, when the inner cylinder 320 is driven up, the variable spring 310 is compressed. For purposes of this disclosure, driving the inner cylinder 320 down may be referred to as a compression action or simply compressing, while driving the inner cylinder 320 up may be referred to as a lifting action or simply lifting.

When the inner cylinder 320 is driven upward to perform a lifting action, the variable spring 310 first compresses in the bottom portion 312 having a lower spring constant. When the bottom portion 312 is fully compressed, the variable spring 310 stiffens due to the spring constant of the top portion 314. Accordingly, in configurations implementing a suction cup at the terminal end 352 of the piston 350, the CPR device may detect whether the suction cup is properly attached to the chest of the patient when a lifting action is performed. More specifically, if the suction cup is not properly attached when the variable spring 310 has stiffened from the bottom portion 312 being compressed, no forces other than those from pretension and weights of the components will act upon the stiffer top portion 314. The CPR device may thus detect displacement of the loose bottom portion 312 alone, indicating that the suction cup is not attached to the chest of the patient. In configurations, therefore, the implementation of the variable spring 310 having both high and low spring constants allows the CPR device to detect separation between the suction cup and the patient's chest at the very beginning of the lifting phase.

Additionally, when the suction cup is properly secured to the patient to perform lifting, a lifting force may be measured in configurations of the disclosed CPR device. In particular, movement of the terminal end 352 of the piston 350 may be compared to the driven motion of the inner cylinder 320. In other words, the distance the terminal end 352 travels may be compared to the distance the inner cylinder 320 is actually lifted, yielding a relative difference. This relative difference corresponds to displacement of the variable spring 310. Hooke's Law—utilizing the known spring constant of the variable spring 310—may thus be applied with the measured displacement to calculate the amount of force required to cause such displacement.

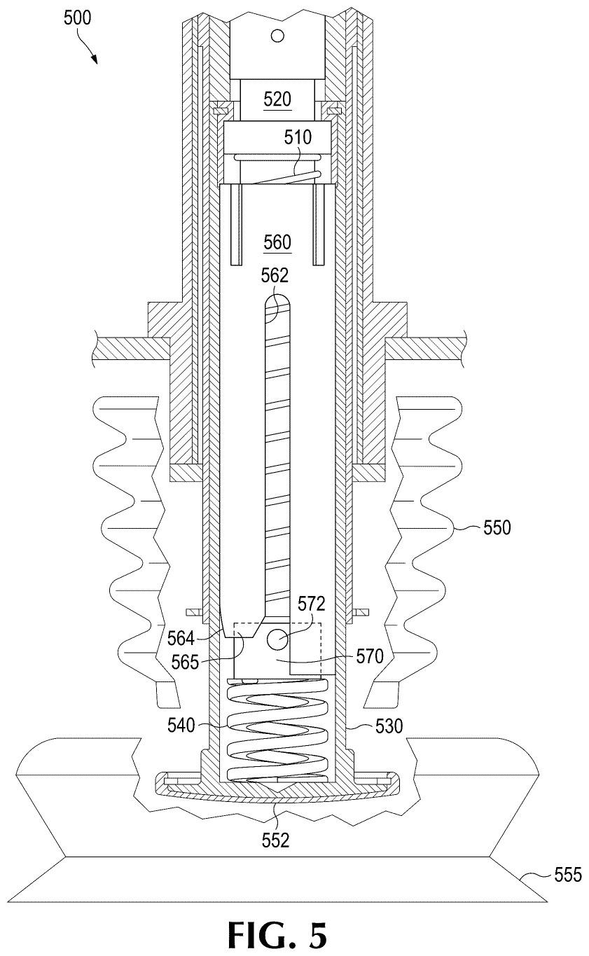

FIG. 4 illustrates a cross section of piston assembly 400, according to an example configuration, showing details of a spring assembly 410 utilizing multiple separate springs within a piston 450. As shown, piston 450 includes an inner cylinder 420 and an outer cylinder 430. Piston 450 also has a terminal end 452, at which a suction cup may be secured. Additionally, spring assembly 410 has a bottom spring 412 having a low spring constant and a top spring 414 having a high spring constant. Piston assembly 400 also has stoppers 416, 418, contacting and being secured to ends of the bottom spring 412 and top spring 414, respectively. Stopper 416, in configurations, is fixed to the inner cylinder 420 and thus moves with the inner cylinder 420 when it is driven up or down. Additionally, a collar 419 may join the ends of the top spring 414 and bottom spring 412 nearest each other within piston 450. In this way, stoppers 416, 418 and collar 419 set initial expansion of the top spring 414 and bottom spring 412 when components of the piston 450 are not in motion, providing pretension for both the top spring 414 and bottom spring 412. Moreover, stoppers 416, 418, and collar 419 facilitate compression and expansion of the top spring 414 and bottom spring 412 during motion of the piston, described in further detail below.

The top spring 414 and bottom spring 412, as shown, surround the inner cylinder 420. Similar to configurations like the example just discussed with regard to FIG. 3, inner cylinder 420 may be driven up and down in a direction along a long axis of the piston 450, for instance, with a ball nut and ball screw arrangement (not illustrated in FIG. 4). Additionally, in configurations, a suction cup may be attached to the terminal end 452 of the outer cylinder 430 to allow the piston 450 to perform a lifting action on a patient's chest. Piston 450 may also include a stiff spring 440, which is positioned to contact an end of the inner cylinder 420 and is secured to an interior portion of the outer cylinder 430 near the terminal end 452. In this way, the stiff spring 440 joins the inner cylinder 420 and outer cylinder 430 such that driving the inner cylinder 420 toward the terminal end 352 compresses the stiff spring 440 within the outer cylinder 430 and causes motion of the outer cylinder 430. For purposes of this disclosure, the stiff spring 440 may be understood as having a high spring constant. For instance, in configurations such as the one illustrated in FIG. 4, the spring constant of the stiff spring 440 may be higher than that of the top spring 414.

Although not illustrated in FIG. 4, piston 450 may include a motor for driving motion of the inner cylinder 420. Specifically, piston 450 may include a rotary motor that rotates a ball screw, causing a ball nut to translate up and down the ball screw along a long axis of the piston 450. Inner cylinder 420, being attached to the ball nut, may thus also translate up and down the ball screw and similarly cause piston 450 to translate. For instance, when the inner cylinder 420 is driven down, the inner cylinder 420 contacts the stiff spring 440. The stiff spring 440, being in contact with an interior portion of the outer cylinder 430, thus acts upon the outer cylinder 430.

When the inner cylinder 420 is driven upward to perform a lifting action, the bottom spring 412 having a lower spring constant is compressed first. When the bottom spring 412 is fully compressed, the combination of springs surrounding the inner cylinder 420 stiffens overall, as the top spring 414 of higher spring constant takes over. Accordingly, in configurations implementing a top spring 414 and bottom spring 412, the CPR device may detect whether the suction cup is properly attached to the chest of the patient when a lifting action is performed. More specifically, if the suction cup is not properly attached when the bottom spring 412 has compressed, no forces other than those from pretension and weights of the components of the piston 450 will act upon the top spring 414. Having a collar 419 separating top spring 414 from bottom spring 412 may provide a distinctive stop when the bottom spring 412 is fully compressed, at which point the CPR device may make such determination of whether the top spring 414 is being displaced. The CPR device may thus detect that the suction cup is not attached to the chest of the patient when the top spring 414 is not being displaced. Therefore, in configurations implementing a separate top spring 414 and bottom spring 412 surrounding the inner cylinder 420, the high and low spring constants may be utilized to detect separation between the suction cup and the patient's chest at the very beginning of the lifting phase.

Additionally, in configurations implementing a suction cup, when the suction cup is properly secured to the patient to perform lifting, a lifting force may be measured. Just as discussed above with regard to configurations implementing a variable spring, such as the example illustrated in FIG. 3, configurations implementing a top spring 414 and bottom spring 412 may similarly allow comparison between the distance the terminal end 452 of piston 450 travels and the distance the inner cylinder 420 is actually lifted. Accordingly, a displacement of the top and bottom springs may be measured and applied in Hooke's Law to calculate an amount of force required to cause such displacement.

In configurations, the stiff spring 440 has a spring constant of 100 N/mm, and the spring assembly 410 has a combined spring constant of 1.5 N/mm. In configurations, the top spring 414 has a spring constant of 20 N/mm, and the bottom spring 412 has a spring constant of 1.6 N/mm. In alternative configurations, the top spring 414 and the bottom spring 412 of the spring assembly 410 have different spring constants from those just mentioned, but the series combination of the spring assembly 410 is 1.5 N/mm. Consequently, most preferably, the combined spring constant of the spring assembly 410 is 1.5 N/mm. Nonetheless, in still other configurations, the spring constant of the spring assembly 410 may be greater or less than 1.5 N/mm.

In configurations such as those discussed with regard to FIGS. 3 and 4, any of the disclosed springs may be industry standard springs. For instance, the disclosed springs may be made from stainless steel, or any other appropriate material providing the desired spring constants listed as examples above.

A rescuer using a CPR device having any spring configuration disclosed above, applying their own expertise and observations of the treatment, may need to switch the CPR device between modes performing compressions and active decompressions. For purposes of this disclosure, the CPR device may be understood as having a standard mode, in which the patient's chest is compressed to a depth below a resting height, and an active decompression mode, in which the patient's chest is lifted to a height above the resting height. Configurations of the disclosed technology provide a rescuer with the ability to manually switch between the standard mode and the active decompression mode where the rescuer determines that such a switch is necessary.

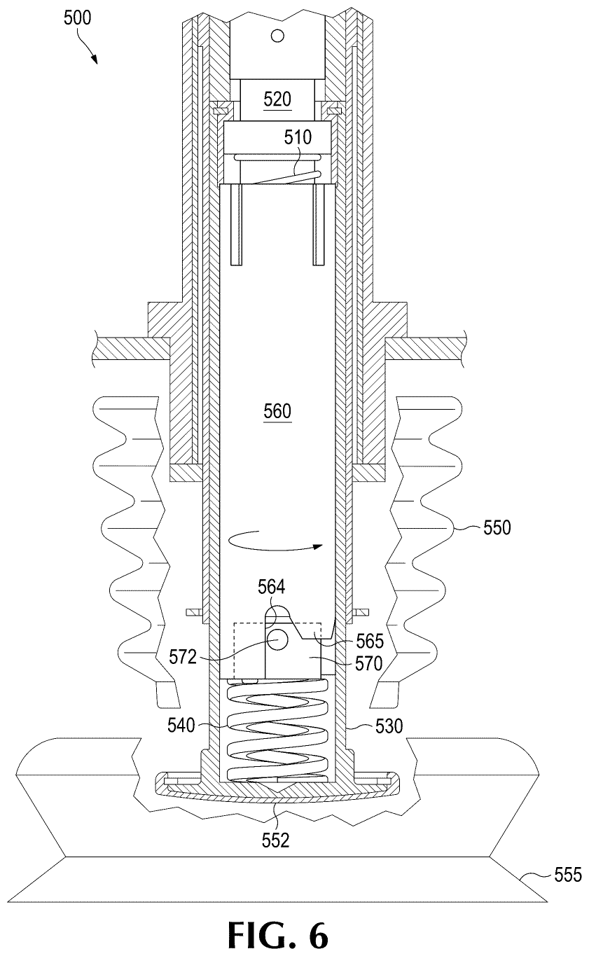

FIG. 5 illustrates a cross section of a piston assembly 500, according to configurations, having a sleeve 560 for manually switching between a standard mode and an active decompression mode. As shown in FIG. 5, piston assembly 500 comprises a piston 500 having an inner cylinder 520, an outer cylinder 530, and an inner spring assembly 510. In configurations, inner spring assembly 510 may comprise a variable spring, and piston 500 may also include a stiff spring 540, such as the example configuration discussed with regard to FIG. 3. Nonetheless, configurations of piston assembly 500 may utilize a separate top spring and bottom spring, as discussed with regard to FIG. 4. As shown, sleeve 560 may be shaped as a cylinder substantially surrounding inner cylinder 520 but substantially contained within outer cylinder 530. As used in this disclosure, “substantially surrounding” means largely or essentially extending around, without requiring perfect encircling, and “substantially contained” means largely or essentially keeping one component within the limits of another component, without requiring the first component be perfectly kept within the limits. Further, piston assembly 500 may have an end cap 570 located at an end of the inner cylinder 520 nearest the stiff spring 540, at which the inner cylinder 520 may act on the stiff spring 540 when it is driven up and down. The end cap 570 may also include a knob 572 extending laterally from a surface of the end cap 570, which may interface with the sleeve 560, as discussed in further detail below. Also, as shown, a terminal end 552 of the piston 550 may be structured such that a suction cup 555 may be attached.

With respect to the structure of piston assembly 500, as shown in FIG. 5, suction cup 555 may be attached at terminal end 552 of the outer cylinder 530, and the suction cup and outer cylinder 530 may be free to rotate together as a unit around a long axis of the piston 550. Additionally, the sleeve 560 may be fixed to the inner surface of the outer cylinder 530 such that the sleeve 560 and outer cylinder 530 may rotate together as a unit when a torque is applied. The end cap 570 is fixed to the inner cylinder 520, and the end cap 570 and inner cylinder 520 are secured within the piston 550 such that they are not able to rotate. Rather, inner cylinder 520 may only translate up and down along the long axis of the piston 550, such as with the ball screw and ball nut described in configurations above. As discussed further below, outer cylinder 530 and sleeve 560 may thus rotate around inner cylinder 520 during either compressions or active decompressions if a rescuer applies a torque to the piston 550.

FIG. 5 shows the piston 550 set in a standard mode. As mentioned, an inner spring assembly 510 according to any of the above-described configurations—namely, a variable spring or a separate top and bottom spring—may be located within the sleeve 560 and may surround the inner cylinder 520. FIG. 5 shows further detail of the sleeve 560. As shown, in configurations, the sleeve 560 has an elongated slot 562. Elongated slot 562 may be formed as a cut-out of material from the sleeve 560, and the elongated slot 562 may be sized to receive the knob 572 of end cap 570. In this way, the elongated slot 562 may be wide enough to receive the knob 572 but not so wide as to allow the end cap 570 to rotate when received in the elongated slot 562. Further, as shown in FIG. 5, sleeve 560 has a lobe 565 and a short slot 564, which are discussed in detail below.

In a standard mode, in which compressions are applied to a patient's chest, sleeve 560 is positioned as shown in FIG. 5. In other words, sleeve 560 is positioned such that knob 572 is received in elongated slot 560. In this way, when inner cylinder 520 is driven up and down within the piston 550, knob 572 is free to translate up and down within elongated slot 565. As previously discussed, inner cylinder may be surrounded by an inner spring assembly 510, such as a variable spring or separate top and bottom springs, in configurations. Accordingly, when inner cylinder 520 is driven to perform compressions and knob 572 is free to translate up and down the length of elongated slot 562, the entire inner spring assembly 510 surrounding inner cylinder 520 is compressed and expanded. For instance, when inner cylinder 520 is driven downward to compress a patient's chest, the patient's chest exerts a normal force. This normal force may cause the portion of the inner spring assembly 510 having a low spring constant to compress, while stiff spring 540 continues to bias the piston 550 against the patient's chest. And, when inner cylinder 520 is driven up and away from the patient's chest, knob 572 can translate up the elongated slot 562 and compress the inner spring assembly 510 surrounding the inner cylinder 520. Accordingly, any upward force from driving the inner cylinder 520 up tends toward compressing the inner spring assembly 510 rather than expanding the stiff spring 540, which prevents the patient from receiving a lifting force.

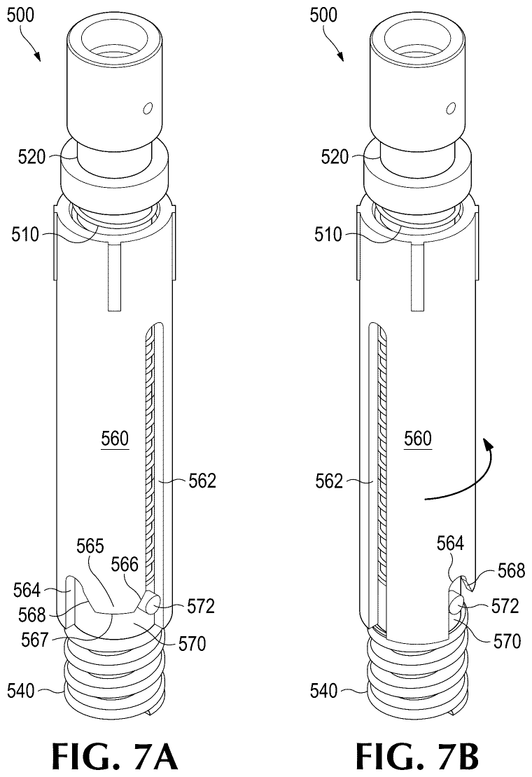

FIG. 6 shows the same internal components of piston assembly 500 from FIG. 5 but with the piston 550 set in an active decompression mode. As shown, in the active decompression mode, sleeve 560 is positioned such that knob 572 is received in short slot 564. Short slot 564 may be formed as a cut-out of material from the sleeve 560, and it may be sized wide enough to receive the knob 572 but not so wide as to allow the end cap 570 to rotate. Short slot 564 is also sized to have minimal length, such that knob 572 is stopped when received in short slot 564. Different from the compression mode, active decompression mode thus does not allow knob 572 to translate when inner cylinder 520 is driven up and down.

In this way, active decompression mode allows a slight compression of the inner spring assembly 510 before the knob 572 is stopped by the short slot 564 and acts upon the sleeve 560. For instance, when inner cylinder 520 is driven upward, short slot 564 prevents knob 572 from translating up and fully compressing the portion of the inner spring assembly 510 having a low spring constant. Instead, when the inner cylinder 520 is driven upward in active decompression mode, the knob acts on the sleeve 560, which is fixed to the outer cylinder 530. Thus, upward force is directed to lifting the sleeve 560 and outer cylinder 530 as a unit, and a lifting force can be applied to the patient's chest.

Moreover, as discussed with regard to configurations of the springs shown in FIGS. 3 and 4, positioning the sleeve 560 in active decompression mode may enable the CPR device to detect that the suction cup 555 is not attached to the patient's chest. For instance, if knob 572 is fully received within short slot 564 and thus contacts the cut-out portion of sleeve 560, the CPR device recognizes that the inner spring assembly 510 has lightly compressed. Therefore, the CPR device can detect that the suction cup is properly attached. However, if the knob 572 sits loosely below short slot 564, and no displacement of the inner spring assembly 510 is detected, the CPR device can detect that the suction cup has separated from the patient's body.

Additionally, as discussed with regard to configurations of the springs shown in FIGS. 3 and 4, a lifting force may be measured when the sleeve 560 of the CPR device is positioned in active decompression mode and lifting actions are performed. More specifically, comparison between the amount the inner cylinder 520 has been lifted and the amount the terminal end 552 has traveled may yield a displacement of the inner spring assembly 510. This displacement of the inner spring assembly 510 may in turn be applied in Hooke's Law to calculate the amount of force required to cause such displacement.

To switch between standard mode and active decompression mode, a rescuer manually applies a torque to the piston 550, which in turn rotates the outer cylinder 530. Because the sleeve 560 is fixed to an interior surface of the outer cylinder 530, the sleeve 560 will rotate with the outer cylinder 530 when such torque is applied. As previously mentioned, sleeve 560 has a lobe 565 between the elongated slot 560 and the short slot 564. The lobe 565 is shaped to have a first angled portion 566 nearest the elongated slot 562, a flat portion 567, and a second angled portion 568 nearest the short slot 564.

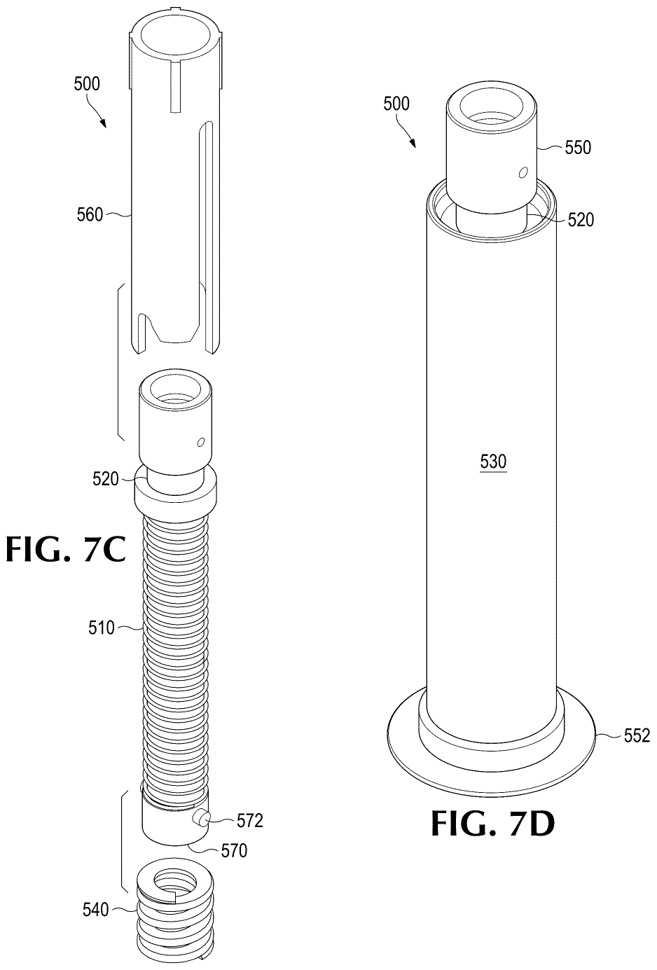

FIG. 7A shows a piston assembly 500, such as the example first illustrated in FIG. 5, initially set in standard mode, wherein knob 572 is received in the elongated slot 562 and springs of the CPR device are pretensioned but are otherwise not compressed or expanded by motion of the piston 550. As shown in FIG. 7B, when a torque is applied in the direction of the arrow, knob 572 may slide along the geometry of the sleeve 560. With reference to FIG. 7A, knob 572 may slide along first angled portion 566 until it reaches flat portion 565. The combination of the inner spring assembly 510 and the stiff spring 540 bias the knob 572 upward and keep the knob 572 in contact with the sleeve 560 as the knob 572 slides along the first angled portion 566. Further rotating the sleeve 560 slides the knob 572 along the flat portion 567, the knob remaining biased against the flat portion 567. Once the sleeve is rotated far enough to reach the second angled portion 568, the biasing force of the springs causes the knob to slide along the second angled portion 568. At this point, as shown in FIG. 7B, the knob 572 will be stopped by the sleeve 560 and be positioned to fit within the short slot 564. Consequently, in FIG. 7B, the sleeve 560 is positioned for active decompression mode.

The reverse of the operations described above may also be performed to switch the CPR device from active decompression mode back to standard mode. For instance, a torque applied in the opposite direction may cause knob 572 to slide along the second angled portion 568, then slide along the flat portion 567 until it reaches the first angled portion 566 and slides back into a position to be received in elongated slot 562.

Because rotating the sleeve 560, in either direction, requires that the knob first be slid down an angled portion to reach the flat portion 567, rotating the sleeve 560 requires compressing the stiff spring 540. Switching between standard mode and active decompression mode thus requires a force strong enough to overcome the stiffness of the stiff spring 540 and compress it. In this way, accidental switching between modes may be prevented, as any potential slips of the knob 572 along either the first angled portion 566 or second angled portion 568 would not be strong enough to compress the stiff spring 540 and cause the knob 572 to reach the flat portion 567 of lobe 565.

FIG. 7C shows an exploded view of the piston assembly 500 just discussed with regard to FIGS. 5-7B. FIG. 7D shows piston assembly 500 fully assembled, including outer cylinder 530. With reference to FIG. 7D, although the inner components are not visible, components of piston assembly 500 such as those shown in FIG. 7C may be substantially contained within the outer cylinder 530. As mentioned with reference to FIG. 7C, inner spring assembly 510 of piston assembly 500 may comprise any configuration utilizing high and low spring constants discussed above, such as variable springs and arrangements having multiple separate springs. In this way, FIG. 7D may be understood as illustrating a fully assembled piston assembly 500 having a sleeve for enabling manual switching between modes and a configuration of inner springs for measuring lifting force and detecting separation from a patient's chest. Furthermore, although a suction cup is not illustrated in FIG. 7D, terminal end 552 of the piston assembly 500 may be configured to have a suction cup secured.

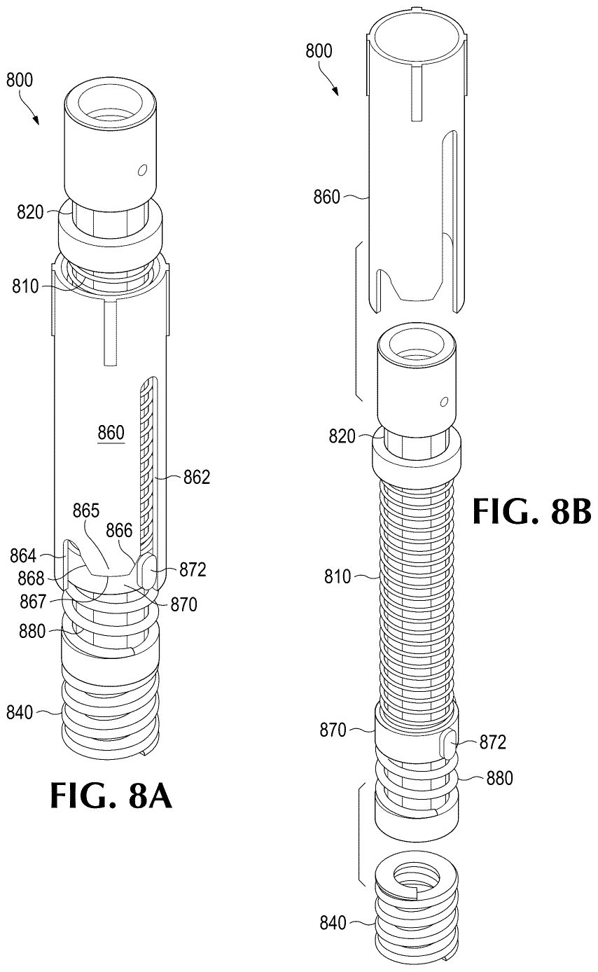

FIGS. 8A-8B shows details of a piston assembly 800, according to an example configuration, having a sleeve 860 implemented with an auxiliary spring 880. In particular, FIG. 8A shows the piston assembly 800 fully assembled, and FIG. 8B shows an exploded view of the piston assembly 800. Similar to configurations just described with regard to FIGS. 5-7D, sleeve 860 has an elongated slot 862 and a short slot 864. Elongated slot 862 and short slot 864 are each wide enough to receive a knob 872 of an end cap 870, but not so wide as to allow the end cap 870 to rotate when the knob 872 is received in either slot. Further, sleeve 860 has a lobe 865. As mentioned, sleeve 860 may be implemented with an auxiliary spring 880. Auxiliary spring 880 is positioned between the stiff spring 840 and the inner spring assembly 810, such that all springs of the piston are in series. Inner spring assembly 810 may be selected according to example configurations described above, such as configurations implementing a variable spring or multiple separate springs. As shown, auxiliary spring 880 may be secured to a portion of the end cap 970 of the inner cylinder 820 nearest the piston's terminal end, thus positioning the auxiliary spring 880 beneath the knob 872 of the end cap 870. Accordingly, in configurations implementing the auxiliary spring 880, auxiliary spring 880 may be acted upon by upward forces along with the stiff spring.

In standard mode, sleeve 860 implemented with auxiliary spring 880 operates similar to configurations described above with regard to FIGS. 5-7D. In standard mode, when the inner cylinder 820 is driven up and down in a piston assembly 800 implementing sleeve 860, the knob 872 is free to translate up and down the length of elongated slot 862. The inner spring assembly 810 may then be compressed and expanded as compressions are performed. In this way, upward force from driving the inner cylinder 820 may tend toward compressing the inner spring assembly 810 rather than expanding the auxiliary spring 880, which prevents the patient from receiving a lifting force.

When sleeve 860 is set in active decompression mode, the sleeve 860 is positioned such that knob 872 is received in short slot 864. In this way, active decompression mode allows a slight compression of the inner spring assembly 810 but largely concentrates forces at the auxiliary spring 880. For instance, when inner cylinder 820 is driven upward, short slot 864 prevents knob 872 from translating up and fully compressing the portion of the inner spring assembly 810 having a low spring constant. Instead, when the inner cylinder 820 is driven upward, upward force is directed to the auxiliary spring 880, which may expand and compress in response to the lifting.

Moreover, as discussed with regard to the sleeve shown in FIGS. 5-7D, configurations of the CPR device having sleeve 860 and an auxiliary spring 880 may detect that the suction cup is not attached to the patient's chest. For instance, if the knob 872 is fully received within short slot 862 and contacts the cut-out portion of sleeve 860, the CPR device recognizes that the inner spring assembly 810 has slightly compressed. Therefore, the CPR device can determine that the suction cup is properly attached. However, if the knob 872 sits loosely below short slot 864, and no displacement of the inner spring assembly 810 is detected, the CPR device can determine that the suction cup has separated from the patient's body.

Additionally, configurations implementing sleeve 860 and auxiliary spring 880 may measure a lifting force when sleeve 860 is positioned in active decompression mode and lifting actions are performed. More specifically, comparison between the amount the inner cylinder 820 has lifted and the amount the terminal end of the piston has traveled may yield a displacement of the auxiliary spring 880. This displacement of the auxiliary spring 880 may in turn be applied in Hooke's Law to calculate the amount of force required to cause such displacement.

To switch between standard mode and active decompression mode in configurations implementing sleeve 860 and auxiliary spring 880, a rescuer may manually apply a torque as described with regard to FIGS. 7A-7B. Sleeve 860, as shown in FIG. 8A, has a lobe 865 comprising a first angled portion 866, a flat portion 867, and a second angled portion 868. Accordingly, to switch from standard mode to active decompression mode, a rescuer may apply a torque such that the knob 872 may slide out of its position in the elongated slot 862 and along the first angled portion 866, the flat portion 867, and the second angled portion 868 until the knob reaches the short slot 864. Similarly, to switch the device back to standard mode, the reverse of the operations may be performed. A torque may be applied in the opposite direction to cause the knob 872 to slide along the second angled portion 868, the flat portion 867, and the first angled portion 866 until the knob 872 slides back into position to be received in the elongated slot 862.

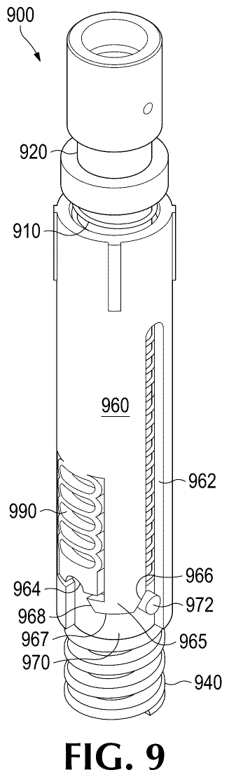

FIG. 9 shows a piston assembly 900 having a sleeve 960 with an incorporated spring 990, according to an example configuration. Similar to configurations just discussed with regard to FIGS. 5-8, sleeve 950 has an elongated slot 962 and a short slot 964. Elongated slot 962 and short slot 964 are each wide enough to receive a knob 972 of an end cap 970, but not so wide as to allow the end cap 970 to rotate when the knob 972 is received in either slot. Further, sleeve 960 has a lobe 965. As mentioned, sleeve 960 has an incorporated spring 990 formed on the surface of sleeve 960. Incorporated spring 990 may accordingly be formed of the same material forming the sleeve 960. As shown, short slot 964 is located on the portion of material forming incorporated spring 990, in configurations, and therefore incorporated spring may be acted upon by knob 972 when the CPR device is set in active decompression mode.

In standard mode, sleeve 960 operates just as described above with regard to the sleeve of FIGS. 5-8 In other words, in standard mode, when an inner cylinder 920 is driven up and down in a piston assembly 900 implementing sleeve 960, knob 972 is free to translate up and down the length of elongated slot 960. An inner spring assembly 910 of the piston assembly 900, which may be chosen from any of the disclosed configurations above, may then be compressed and expanded as compressions are performed. In this way, upward force from driving the inner cylinder 920 up tends toward compressing the inner spring assembly 910, which prevents the patient from receiving a lifting force.

When sleeve 960 is set in active decompression mode, the sleeve 960 is positioned such that knob 972 is received in short slot 964. Although short slot 964 is sized to have minimal length, as shown in FIG. 9, the displacement of incorporated spring 990 allows some translation of the knob 972 along the length of the sleeve 960. In this way, active decompression mode in a CPR device implementing sleeve 960 allows slight compression and expansion of the inner spring assembly 910, as well as compression and expansion of the incorporated spring 990. For instance, when inner cylinder 920 is driven upward, short slot 964 initially prevents the knob 972 from translating, but the incorporated spring 990 compresses such that the short slot 964 and knob translate together along the length of sleeve 960. This translation due to compression of incorporated spring 990 further acts on sleeve 960 itself and causes it to translate upward, applying a lifting force to the patient's chest.

Moreover, just as discussed with regard to the sleeve shown in FIGS. 5-8, configurations of the CPR device having sleeve 960 may detect that the suction cup is not attached to the patient's chest. For instance, if knob 972 is fully received within short slot 964 and contacts the cut-out portion of sleeve 960, the CPR device recognizes that the inner spring assembly 910 and incorporated spring 990 have compressed. Therefore, the CPR device can determine that the suction cup is properly attached. However, if the knob 972 sits loosely below short slot 964, and no displacement of the inner spring assembly 910 or incorporated spring 990 is detected, the CPR device can detect that the suction cup has separated from the patient's body.

Additionally, configurations implementing sleeve 960 may measure a lifting force when sleeve 960 is positioned in active decompression mode and lifting actions are performed. More specifically, comparison between the amount the inner cylinder 920 has lifted and the amount a terminal end of a piston assembly 900 has traveled may yield a displacement of the stiff spring 940. This displacement of the stiff spring 940 may in turn be applied in Hooke's Law to calculate the amount of force required to cause such displacement. In configurations implementing sleeve 960, incorporated spring 990 may improve the accuracy of such a measurement, as the additional spring may smooth the expansion and compression of the stiff spring 940.

To switch between standard mode and active decompression mode in configurations implementing sleeve 960, a rescuer may manually apply a torque as described with regard to FIGS. 7A-7B. Sleeve 960, as shown in FIG. 9, has a lobe 965 comprising a first angled portion 966, a flat portion 967, and a second angled portion 968. Accordingly, to switch from standard mode to active decompression mode, a rescuer may apply a torque such that the knob 972 of the inner cylinder 920 may slide out of its position in the elongated slot 962 and along the first angled portion 966, the flat portion 967, and the second angled portion 968 until the knob 972 reaches the short slot 964. Similarly, to switch the device back to standard mode, the reverse of the operations may be performed. A torque may be applied in the opposite direction to cause the knob 972 to slide along the second angled portion 968, the flat portion 967, and the first angled portion 966 until the knob 972 slides back into position to be received in the elongated slot 962.

In any of the configurations described above, the sleeve may be formed from a low friction material, such as a low friction plastic, or plastic reinforced with carbon fiber, aramid, or carbon fiber. In configurations implementing an incorporated spring, such as the example configuration shown in FIG. 9, the sleeve may be formed from reinforced plastics as described, and the incorporated spring is formed from steel and overmolded with the reinforced plastic.

### EXAMPLES

Illustrative examples of the disclosed technologies are provided below. A particular configuration of the technologies may include one or more, and any combination of, the examples described below.

Example 1 includes a mechanical cardiopulmonary resuscitation (“CPR”) device comprising: a piston comprising: a piston rod, a piston sleeve concentric to the piston rod and configured to slide relative to the piston rod in a first direction, a first spring having a first spring rate and being configured to resist movement of the piston sleeve in the first direction, and a second spring having a second spring rate and being configured to resist movement of the piston sleeve in the first direction, the first spring rate being lower than the second spring rate, the first spring and the second spring being in series; and a driver coupled to the piston and configured to extend the piston toward a chest of a patient and retract the piston away from the chest of the patient.

Example 2 includes the mechanical CPR device of Example 1, in which the first spring rate is less than the second spring rate.

Example 3 includes the mechanical CPR device of any of Examples 1-2, in which the driver is coupled to the piston rod.

Example 4 includes the mechanical CPR device of any of Examples 1-3, further comprising a suction cup mounted to the piston sleeve.

Example 5 includes the mechanical CPR device of any of Examples 1-4, further comprising a support structure configured to position the piston over the chest of the patient.

Example 6 includes a mechanical cardiopulmonary resuscitation (“CPR”) device comprising: a piston comprising: a piston rod, a piston sleeve concentric to the piston rod and configured to slide relative to the piston rod in a first direction, and a spring configured to resist movement of the piston sleeve in the first direction, the spring having a first spring rate from a pretensioned position to a first deflection distance, the spring having a second spring rate from the first deflection distance to a second deflection distance, the second deflection distance being greater than the first deflection distance, the second spring rate being greater than the first spring rate; and a driver coupled to the piston and configured to extend the piston toward a chest of a patient and retract the piston away from the chest of the patient.

Example 7 includes the mechanical CPR device of Example 6, in which the spring is a compression spring, the first deflection distance is a first compression amount, and the second deflection distance is a second compression amount.

Example 8 includes a mechanical cardiopulmonary resuscitation (“CPR”) device comprising: a piston comprising: a piston rod, a piston sleeve concentric to the piston rod and configured to slide relative to the piston rod in a first direction, and a spring device configured to resist movement of the piston sleeve in the first direction, the spring device having a first spring rate from a zero deflection distance to a first deflection distance, the spring device having a second spring rate from the first deflection distance to a second deflection distance, the second deflection distance being greater than the first deflection distance, the second spring rate being greater than the first spring rate; and a driver coupled to the piston and configured to extend the piston toward a chest of a patient and retract the piston away from the chest of the patient.

Example 9 includes the mechanical CPR device of example 8, in which the spring device comprises: a first spring having the first spring rate and configured to resist movement of the piston sleeve in the first direction; and a second spring having the second spring rate and configured to resist movement of the piston sleeve in the first direction, the first spring and the second spring being in series.

Example 10 includes the mechanical CPR device of any of example 8-9, in which the spring device comprises a single compression spring having the first spring rate from the zero deflection distance to the first deflection distance and the second spring rate from the first deflection distance to the second deflection distance.

Example 11 includes a method of determining a lifting force on a piston of a mechanical cardiopulmonary resuscitation (“CPR”) device, the method comprising: determining a distance traveled by a piston rod in a first direction, the distance traveled by the piston rod being relative to a driver coupled to the piston rod and configured to retract the piston rod away from a chest of a patient; measuring a distance traveled by a piston sleeve in the first direction, the piston sleeve being concentric to the piston rod and configured to slide relative to the piston rod in the first direction, the piston sleeve being coupled to the piston rod through a first spring having a first spring rate that is configured to resist movement of the piston sleeve in the first direction as well as a second spring having a second spring rate that is configured to resist movement of the piston sleeve in the first direction, the first spring rate being lower than the second spring rate, the first spring and the second spring being in series; determining a relative distance by subtracting the distance traveled by the piston sleeve in the first direction from the distance traveled by the piston rod in the first direction; and multiplying the relative distance by the second spring rate.

Example 12 includes the method of Example 11, in which the measuring the distance traveled by the piston sleeve is by a linear sensor.

Example 13 includes the method of any of Examples 11-12, in which the driver comprises a motor and a ball screw, the ball screw configured to drive the piston rod, and in which the determining the distance traveled by the piston rod is by determining a number of rotations of the motor.

Example 14 includes a method of determining a lifting force on a piston of a mechanical cardiopulmonary resuscitation (“CPR”) device, the piston comprising: determining a distance traveled by a piston rod in a first direction, the distance traveled by the piston rod being relative to a driver coupled to the piston rod and configured to retract the piston rod away from a chest of a patient; measuring a distance traveled by a piston sleeve in the first direction, the piston sleeve being concentric to the piston rod and configured to slide relative to the piston rod in the first direction, the piston sleeve being coupled to the piston rod through a spring configured to resist movement of the piston sleeve in the first direction, the spring having a first spring rate from a zero deflection distance to a first deflection distance, the spring having a second spring rate from the first deflection distance to a second deflection distance, the second deflection distance being greater than the first deflection distance, the second spring rate being greater than the first spring rate; determining a relative distance by subtracting the distance traveled by the piston sleeve in the first direction from the distance traveled by the piston rod in the first direction; and multiplying the relative distance by the second spring rate.

Example 15 includes a method of determining a lifting force on a piston of a mechanical cardiopulmonary resuscitation (“CPR”) device, the piston comprising: determining a distance traveled by a piston rod in a first direction, the distance traveled by the piston rod being relative to a driver coupled to the piston rod and configured to retract the piston rod away from a chest of a patient; measuring a distance traveled by a piston sleeve in the first direction, the piston sleeve being concentric to the piston rod and configured to slide relative to the piston rod in the first direction, the piston sleeve being coupled to the piston rod through a spring device configured to resist movement of the piston sleeve in the first direction, the spring device having a first spring rate from a zero deflection distance to a first deflection distance, the spring device having a second spring rate from the first deflection distance to a second deflection distance, the second deflection distance being greater than the first deflection distance, the second spring rate being greater than the first spring rate; determining a relative distance by subtracting the distance traveled by the piston sleeve in the first direction from the distance traveled by the piston rod in the first direction; and multiplying the relative distance by the second spring rate.

Example 16 includes a mechanical cardiopulmonary resuscitation (“CPR”) device comprising: a piston comprising: a piston rod, a piston sleeve concentric to the piston rod and configured to slide relative to the piston rod in a first direction, and a spring device configured to resist movement of the piston sleeve in the first direction, the spring device having a first spring rate from a zero deflection distance to a first deflection distance, the spring device having a second spring rate from the first deflection distance to a second deflection distance, the second deflection distance being greater than the first deflection distance, the second spring rate being greater than the first spring rate; and a driver coupled to the piston and configured to extend the piston toward a chest of a patient and retract the piston away from the chest of the patient.

Example 17 includes the mechanical CPR device of any of Examples 8-10, in which the spring device comprises: a first spring having the first spring rate and configured to resist movement of the piston sleeve in the first direction; and a second spring having the second spring rate and configured to resist movement of the piston sleeve in the first direction, the first spring and the second spring being in series.

Example 18 includes the mechanical CPR device of any of Examples 8-10 and 17, in which the spring device comprises a single compression spring having the first spring rate from the zero deflection distance to the first deflection distance and the second spring rate from the first deflection distance to the second deflection distance.

Example 19 includes a mechanical cardiopulmonary resuscitation (“CPR”) device comprising: a piston comprising: a piston rod having a knob at an end of the piston rod; a piston sleeve concentric to the piston rod and configured to rotate about a long axis of the piston when a torque is applied, the piston sleeve structured to receive the knob of the piston rod in a first slotted position corresponding to a first treatment mode and receive the knob of the piston rod in a second slotted position corresponding to a second treatment mode; and a driver coupled to the piston and configured to extend the piston toward a chest of a patient when the knob is received in the first slotted position corresponding to the first treatment mode and retract the piston away from the chest of the patient when the knob is received in the second slotted position corresponding to the second treatment mode.

Example 20 includes the mechanical CPR device of Example 19, in which the piston sleeve further includes a lobe between the first slotted position and the second slotted position.

Example 21 includes the mechanical CPR device of Example 20, in which the lobe is structured to have a first angled portion, a flat portion, and a second angled portion.

Example 22 includes the mechanical CPR device of Example 21, in which applying a torque to the piston sleeve in a first direction moves the sleeve from the first slotted position and causes the first angled portion, the flat portion, and the second angled portion to slide along the knob until the knob is positioned in the second slotted position.

Example 23 includes the mechanical CPR device of any of Examples 20-21, in which applying a torque to the piston sleeve in a second direction moves from the sleeve from the second slotted position and causes the second angled portion, the flat portion, and the first angled portion to slide along the knob until the knob is positioned in the first slotted position.

Example 24 includes the mechanical CPR device of any of Examples 19-23, in which the first treatment mode is a compression mode and the second treatment mode is an active decompression mode.

Example 25 includes the mechanical CPR device of any of Examples 19-24, in which the piston further includes an inner spring assembly.

Example 26 includes the mechanical CPR device of any of Example 25, in which the knob is configured to translate back and forth along an axis parallel to the long axis of the piston when the knob is received in the first slotted position, and wherein translating back and forth acts on the inner spring assembly.

Example 27 includes a mechanical cardiopulmonary resuscitation (“CPR”) device comprising: a piston comprising: a piston rod, a piston sleeve concentric to the piston rod and configured to rotate about a long axis of the piston when a torque is applied, the piston sleeve structured to be positioned relative to the piston rod in a first mode and a second mode; and a driver coupled to the piston and configured to extend the piston toward a chest of a patient when the piston sleeve is positioned in the first mode and retract the piston away from the chest of the patient when the piston sleeve is positioned in the second mode.

Example 28 includes the mechanical CPR device of Example 27, in which the piston sleeve has an elongated slot corresponding to the first mode and a short slot corresponding to the second mode.

Example 29 includes the mechanical CPR device of Example 28, in which the piston rod includes a knob structured to be received in the elongated slot to position the piston sleeve in the first mode and structured to be received in the short slot to position the piston sleeve in the second mode.

Example 30 includes the mechanical CPR device of any of Examples 28-29, in which the piston sleeve further includes a lobe between the elongated slot and the short slot.

Example 31 includes the mechanical CPR device of Example 30, in which the lobe is structured to have a first angled portion, a flat portion, and a second angled portion.

Example 32 includes the mechanical CPR device of Example 31, in which applying a torque to the piston sleeve in a first direction moves the elongated slot off the knob and causes the first angled portion, the flat portion, and the second angled portion to slide along the knob until the knob is positioned in the short slot.

Example 33 includes the mechanical CPR device of any of Examples 31-32, in which applying a torque to the piston sleeve in a second direction moves the short slot off the knob and causes the second angled portion, the flat portion, and the first angled portion to slide along the knob until the knob is positioned in the elongated slot.

Example 34 includes the mechanical CPR device of any of Examples 27-33, in which the piston further includes an inner spring assembly.

Example 35 includes the mechanical CPR device of Example 34, in which a knob of the piston rod is configured to translate back and forth along an axis parallel to the long axis of the piston and act upon the inner spring assembly when the piston sleeve is positioned in the first mode.

Example 36 includes a method of manually adjusting a lifting force of a piston of a mechanical cardiopulmonary resuscitation (“CPR”) device, the method comprising: positioning a piston sleeve in a first mode; applying a torque to a piston sleeve concentric to a piston rod to move the piston sleeve from the first mode to a second mode; and positioning the piston sleeve in the second mode.

Example 37 includes the method of Example 36, in which positioning the piston sleeve in the first mode comprises receiving a knob of the piston in a first slot on the piston sleeve.

Example 38 includes the method of any of Examples 36-37, in which positioning the piston sleeve in the second mode comprises receiving a knob of the piston in a second slot on the piston sleeve.

Example 39 includes a mechanical cardiopulmonary resuscitation (“CPR”) device comprising: a piston comprising: a piston rod, a piston sleeve concentric to the piston rod and configured to rotate about a long axis of the piston when a torque is applied, the piston sleeve structured to be positioned relative to the piston rod in a first mode and a second mode, the position having a spring molded onto an outer surface of the sleeve and structured to be acted upon when the sleeve is positioned in the second mode; and a driver coupled to the piston and configured to extend the piston toward a chest of a patient when the piston sleeve is positioned in the first mode and retract the piston away from the chest of the patient when the piston sleeve is positioned in the second mode.

Example 40 includes the mechanical CPR device of Example 39, in which the piston sleeve has an elongated slot corresponding to the first mode and a short slot corresponding to the second mode.

Example 41 includes the mechanical CPR device of Example 40, in which the piston rod includes a knob structured to be received in the elongated slot to position the piston sleeve in the first mode and structured to be received in the short slot to position the piston sleeve in the second mode.

Example 42 includes the mechanical CPR device of any of Examples 39-41, in which the piston sleeve further includes a lobe between the elongated slot and the short slot.

Example 43 includes the mechanical CPR device of Example 42, in which the lobe is structured to have a first angled portion, a flat portion, and a second angled portion.

Example 44 includes the mechanical CPR device of Example 43, in which applying a torque to the piston sleeve in a first direction causes the elongated slot to move off the knob and causes the first angled portion, the flat portion, and the second angled portion to slide along the knob until the knob is positioned in the short slot.

Example 45 includes the mechanical CPR device of any of Examples 43-44, in which applying a torque to the piston sleeve in a second direction causes the short slot to move off the knob and causes the second angled portion, the flat portion, and the first angled portion to slide along the knob until the knob is positioned in the elongated slot.

Example 46 includes the mechanical CPR device of any of Examples 39-45, in which the piston further includes an inner spring assembly.

Example 47 includes the mechanical CPR device of Example 46, in which a knob of the piston rod is configured to translate back and forth along an axis parallel to the long axis of the piston and act upon the inner spring assembly when the piston sleeve is positioned in the first mode.

Example 48 includes a mechanical cardiopulmonary resuscitation (“CPR”) device comprising: a piston comprising: a piston rod, a piston sleeve concentric to the piston rod and configured to rotate about a long axis of the piston when a torque is applied; a driver coupled to the piston and configured to extend the piston toward a chest of a patient and retract the piston away from the chest of the patient to apply a lifting force to the chest of the patient; and wherein rotating the piston sleeve about the long axis of the piston adjusts a lifting force.

Example 49 includes the mechanical CPR device of Example 48, in which rotating the piston sleeve about the long axis of the piston comprises moving the piston sleeve between a first position and a second position.

Example 50 includes the mechanical CPR device of any of Examples 48-49, in which the lifting force applied by the piston in the second position is greater than the lifting force applied by the piston in the first position.

Example 51 includes the mechanical CPR device of any of Examples 48-50, in which the mechanical CPR device is further configured to measure the applied lifting force.

Aspects may operate on a particularly created hardware, on firmware, digital signal processors, or on a specially programmed general purpose computer including a processor operating according to programmed instructions. The terms “controller” or “processor” as used herein are intended to include microprocessors, microcomputers, ASICs, and dedicated hardware controllers. One or more aspects may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, RAM, etc. As will be appreciated by one of skill in the art, the functionality of the program modules may be combined or distributed as desired in various configurations. In addition, the functionality may be embodied in whole or in part in firmware or hardware equivalents such as integrated circuits, field programmable gate arrays (FPGA), and the like. Particular data structures may be used to more effectively implement one or more aspects of the disclosed systems and methods, and such data structures are contemplated within the scope of computer executable instructions and computer-usable data described herein.

The previously described versions of the disclosed subject matter have many advantages that were either described or would be apparent to a person of ordinary skill. Even so, all of these advantages or features are not required in all versions of the disclosed apparatus, systems, or methods.

Additionally, this written description makes reference to particular features. It is to be understood that the disclosure in this specification includes all possible combinations of those particular features. For example, where a particular feature is disclosed in the context of a particular example configuration, that feature can also be used, to the extent possible, in the context of other example configurations.

Also, when reference is made in this application to a method having two or more defined steps or operations, the defined steps or operations can be carried out in any order or simultaneously, unless the context excludes those possibilities.

Furthermore, the term “comprises” and its grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components.

Also, directions such as “vertical,” “horizontal,” “right,” and “left” are used for convenience and in reference to the views provided in figures. But the CPR device may have a number of orientations in actual use. Thus, a feature that is vertical, horizontal, to the right, or to the left in the figures may not have that same orientation or direction in actual use.

Although specific example configurations have been described for purposes of illustration, it will be understood that various modifications may be made without departing from the spirit and scope of the disclosure.

We claim:

1. A mechanical cardiopulmonary resuscitation (“CPR”) device comprising:
a piston comprising:
a piston rod,
a piston sleeve concentric to the piston rod and configured to slide relative to the piston rod in a first direction,
a first spring having a first spring rate and being configured to resist movement of the piston sleeve in the first direction, and
a second spring having a second spring rate and being configured to resist movement of the piston sleeve in the first direction, the first spring rate being lower than the second spring rate,
the first spring and the second spring being in series; and
a driver coupled to the piston and configured to extend the piston toward a chest of a patient and retract the piston away from the chest of the patient.

2. The mechanical CPR device of claim 1, further comprising a collar positioned between the first spring and the second spring, the collar structured to provide pretension for the first spring and the second spring.

3. The mechanical CPR device of claim 1, in which the driver is coupled to the piston rod.

4. The mechanical CPR device of claim 1, further comprising a suction cup mounted to the piston sleeve.

5. The mechanical CPR device of claim 4, in which the suction cup is configured to attach to the chest of the patient, and in which retracting the piston away from the chest of the patient lifts the chest of the patient.

6. The mechanical CPR device of claim 5, in which the mechanical CPR device is configured to determine a lifting force based at least in part on displacement of the second spring.

7. The mechanical CPR device of claim 5, in which the mechanical CPR device is configured to determine that the suction cup has detached from the chest of the patient based at least in part on displacement of the second spring.

8. The mechanical CPR device of claim 1, further comprising a support structure configured to position the piston over the chest of the patient.

9. A mechanical cardiopulmonary resuscitation (“CPR”) device comprising:
a piston comprising:
a piston rod,
a piston sleeve concentric to the piston rod and configured to slide relative to the piston rod in a first direction, and
a spring configured to resist movement of the piston sleeve in the first direction, the spring having a first spring rate from a pretensioned position to a first deflection distance, the spring having a second spring rate from the first deflection distance to a second deflection distance, the second deflection distance being greater than the first deflection distance, the second spring rate being greater than the first spring rate; and
a driver coupled to the piston and configured to extend the piston toward a chest of a patient and retract the piston away from the chest of the patient.

10. The mechanical CPR device of claim 9, in which the spring is a compression spring, the first deflection distance is a first compression amount, and the second deflection distance is a second compression amount.

11. The mechanical CPR device of claim 9, in which the driver is coupled to the piston rod.

12. The mechanical CPR device of claim 9, further comprising a suction cup mounted to the piston sleeve.

13. A mechanical cardiopulmonary resuscitation (“CPR”) device comprising:
a piston comprising:
a piston rod,
a piston sleeve concentric to the piston rod and configured to slide relative to the piston rod in a first direction, and
a spring device configured to resist movement of the piston sleeve in the first direction, the spring device having a first spring rate from a zero deflection distance to a first deflection distance, the spring device having a second spring rate from the first deflection distance to a second deflection distance, the second deflection distance being greater than the first deflection distance, the second spring rate being greater than the first spring rate; and
a driver coupled to the piston and configured to extend the piston toward a chest of a patient and retract the piston away from the chest of the patient.

14. The mechanical CPR device of claim 13, in which the spring device comprises:
a first spring having the first spring rate and configured to resist movement of the piston sleeve in the first direction; and
a second spring having the second spring rate and configured to resist movement of the piston sleeve in the first direction, the first spring and the second spring being in series.

15. The mechanical CPR device of claim 13, in which the spring device comprises a single compression spring having the first spring rate from the zero deflection distance to the first deflection distance and the second spring rate from the first deflection distance to the second deflection distance.

16. The mechanical CPR device of claim 13, in which the driver is coupled to the piston rod.

17. The mechanical CPR device of claim 13, further comprising a suction cup mounted to the piston sleeve.

18. The mechanical CPR device of claim 17, in which the suction cup is configured to attach to the chest of the patient, and in which retracting the piston away from the chest of the patient lifts the chest of the patient.

19. The mechanical CPR device of claim 18, in which the mechanical CPR device is configured to determine a lifting force based at least in part on displacement of the second spring.

20. The mechanical CPR device of claim 18, in which the mechanical CPR device is configured to determine that the suction cup has detached from the chest of the patient based at least in part on displacement of the second spring.
